(19) United States
(12) Patent Application Publication
(10) Pub. No.: US 2009/0219791 A1
(43) Pub. Date: Sep. 3, 2009

(54) OPTICAL DISC APPARATUS AND TRACKING CONTROL METHOD

(75) Inventor: Satoru Maeda, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/356,403

(22) Filed: Jan. 20, 2009

(30) Foreign Application Priority Data
Feb. 28, 2008 (JP) 2008-048416

(51) Int. Cl. G11B 7/00; G11B 20/18

(52) U.S. Cl. 369/44.11; 369/53.17; G9B/7

(57) ABSTRACT

According to one embodiment, an optical disc apparatus includes track error signal generation module for generating, on the basis of a detection result by a light detection module, a second track error signal which is used for tracking control, wherein the track error signal generation module includes module for extracting low-frequency components of signals which are detected by light-receiving units of the light detection module and performing a subtraction between the low-frequency components, thereby generating a first track error signal, extraction module for extracting high-frequency components of the signals which are detected by the light-receiving units detection module for detecting envelope signals of the high-frequency components, module for generating a compensation signal by performing an addition of the envelope signals or a subtraction between the envelope signals, and compensation module for compensating the first track error signal by using the compensation signal thereby generating the second track error signal.

### CROSS-REFERENCE TO RELATED APPLICATIONS

This application is based upon and claims the benefit of priority from Japanese Patent Application No. 2008-048416, filed Feb. 28, 2008, the entire contents of which are incorporated herein by reference.

### BACKGROUND

1. Field

One embodiment of the present invention relates to an optical disc apparatus and a tracking control method.

2. Description of the Related Art

Read-only optical discs or recordable optical discs, such as CDs (Compact Discs), DVDs (Digital Versatile Discs) and HD DVDs (High Definition Digital Versatile Discs), have been used as recording media which are capable of storing digital video.

When tracking control is executed to record/reproduce data on/from the optical disc, there are known an optical disc apparatus and a tracking control method, wherein a track error signal is generated by a push-pull method.

In this optical disc apparatus, a laser beam, which is emitted from a laser light source, is radiated on an information recording surface of the optical disc through an objective lens. Further, return light is received by a light-receiving element. In the optical disc apparatus, low-frequency components of signals, which are output from the channels of the light-receiving element, are extracted, and subtraction is performed between these low-frequency components, thereby producing a track error signal. On the basis of the track error signal, tracking control is executed.

There has been proposed a conventional optical disc apparatus and a tracking control method, wherein a side beam is so set as to scan a position with an offset in the radial direction of the optical disc 22 by an about (¼+n)P or (¾+n)P, relative to a main beam from a laser light source, and a difference signal is generated from push-pull signals PPs1 and PPs2 of return light of the side beam, thereby generating a track cross signal TCS (see Patent Document 1).

Even if the above-described track control is executed, however, when a servo is executed on a non-recorded track, whose neighboring track is a recorded track, or on a recorded track, whose neighboring track is a non-recorded track, the return light from the optical disc is influenced by the neighboring track, and there may arise such a case that a non-negligible offset occurs in a track error signal. In such a case, track servo stability is deteriorated, and a problem such as track slip may occur.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 schematically shows an example of an optical disc apparatus according to a first embodiment of the present invention;

FIG. 2 is a view for explaining an example of the structure of a track error signal generating unit of the optical disc apparatus shown in FIG. 1;

FIG. 3A shows an example of a signal waveform which is used in tracking control according to the first embodiment of the invention;

FIG. 3B shows an example of a signal waveform which is used in tracking control according to the first embodiment of the invention;

FIG. 3C shows an example of a signal waveform which is used in tracking control according to the first embodiment of the invention;

FIG. 3D shows an example of a signal waveform which is used in tracking control according to the first embodiment of the invention;

FIG. 3E shows an example of a signal waveform which is used in tracking control according to the first embodiment of the invention;

FIG. 3F shows an example of a signal waveform which is used in tracking control according to the first embodiment of the invention;

FIG. 4 is a flow chart for describing an example of a tracking control method according to the first embodiment of the invention;

FIG. 5 schematically shows an example of an optical disc apparatus according to a second embodiment of the invention;

FIG. 6A shows an example of a signal waveform which is used in a tracking control method according to the second embodiment of the invention;

FIG. 6B shows an example of a signal waveform which is used in the tracking control method according to the second embodiment of the invention;

FIG. 6C shows an example of a signal waveform which is used in the tracking control method according to the second embodiment of the invention; and

FIG. 6D shows an example of a signal waveform which is used in the tracking control method according to the second embodiment of the invention.

### DETAILED DESCRIPTION

Various embodiments according to the invention will be described hereinafter with reference to the accompanying drawings. In general, according to one embodiment of the invention, there is provided an optical disc apparatus comprising a light source device which radiates light on a recording medium; light detection means for detecting return light from the recording medium; track error signal generation means for generating, on the basis of a detection result by the light detection means, a second track error signal which is used for tracking control; and control means for executing tracking control on the basis of the second track error signal, wherein the track error signal generation means includes: means for extracting a plurality of low-frequency components of signals which are detected by a plurality of light-receiving units of the light detection means, and performing a subtraction between the plurality of low-frequency components, thereby generating a first track error signal; extraction means for extracting high-frequency components of the signals which are detected by the plurality of light-receiving units of the light detection means; detection means for detecting envelope signals of the high-frequency components which are obtained by the extraction means; means for generating a compensation signal by performing an addition of the envelope signals obtained by the detection means or a subtraction between the envelope signals; and compensation means for compensating the first track error signal by using the compensation signal, thereby generating the second track error signal.

An optical disc apparatus and a tracking control method according to a first embodiment of the present invention will now be described with reference to the accompanying drawings.

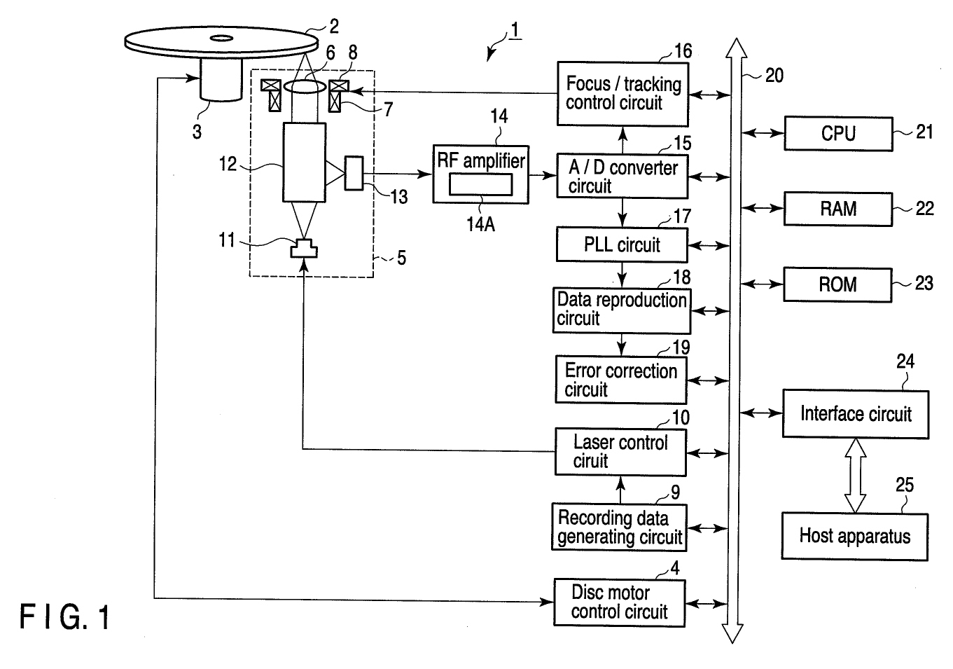

FIG. 1 is a block diagram showing an optical disc apparatus 1 according to the first embodiment of the invention. An optical disc 2 is a read-only optical disc or a recordable optical disc, such as a CD, a DVD or an HD DVD. Examples of the DVD include read-only DVDs, such as a DVD-Video and a DVD-ROM (Read-Only Memory), and recordable DVDs, such as a DVD-R (Recordable), a DVD-RW (Rewritable) and a DVD-RAM (Random Access Memory).

The optical disc 2 in this optical disc apparatus 1 according to the present embodiment is formed of an LtoH-type recording material in which the degree of light absorption decreases after recording, compared to that before recording.

The optical disc 2 is rotated by a disc motor 3. The disc motor 3 is controlled by a disc motor control circuit 4. Recording/reproduction of information on/from the optical disc 2 is performed by an optical pickup 5. An objective lens 6 is provided in the optical pickup 5. The objective lens 6 is movable in a focusing direction (i.e. the optical axis direction of the lens) by the driving of a focusing actuator 7, and is movable in a tracking direction (i.e. the radial direction of the optical disc, which is perpendicular to the optical axis direction of the lens) by the driving of a tracking actuator 8.

A recording data generating circuit 9 adds an error correction code to data which is supplied from a host apparatus 25 via an interface circuit 24 at a time of information recording, and adds a sync code, etc. to the data, thereby altering the data to data in a recording format. Further, the recording data generating circuit 9 modulates the data in the recording format, and delivers the modulated data to a laser control circuit 10. At a time of information recording (at a time of mark formation), on the basis of the data delivered from the recording data generating circuit 9, the laser control circuit 10 supplies a write signal to a laser diode 11 in the optical pickup 5.

The laser diode 11 is selected from among a laser diode for CDs with a wavelength of about 780 nm (nanometer), a laser diode for DVDs with a wavelength of about 650 nm, and a laser diode for HD DVDs with a wavelength of about 405 nm. One of these laser diodes is selectively used in accordance with the kind of the optical disc 2 which is loaded in the optical disc apparatus 1. One of the laser diodes is selected in accordance with a signal that is supplied from the laser control circuit 10, and emits a laser beam.

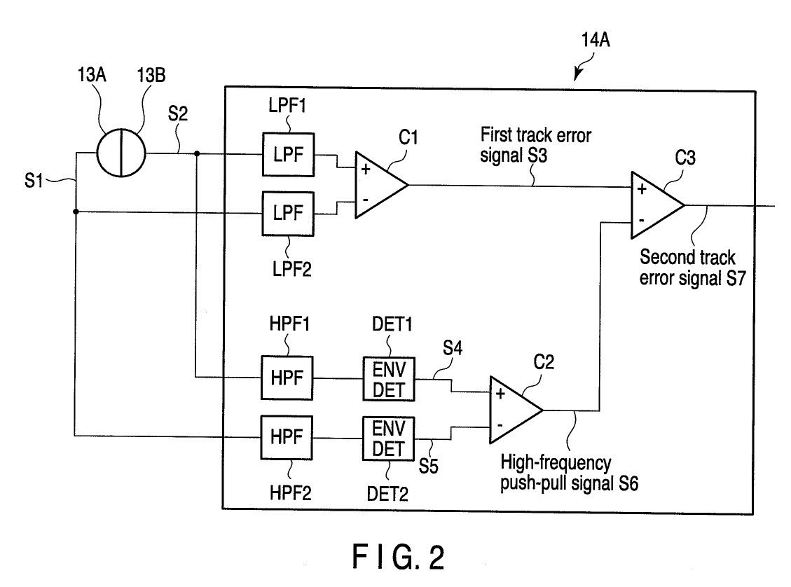

The laser beam, which is emitted from the laser diode 11, is radiated on the optical disc 2 via an optical unit 12 and the objective lens 6. Reflective light of the laser beam, which is emitted from the laser diode 11 and reflected by the optical disc 2, is led to a photodetector 13 via the objective lens 6 and optical unit 12. As shown in FIG. 2, the photodetector 13 according to the present embodiment includes, for example, two light-receiving units 13A and 13B. These two light-receiving units 13A and 13B are arranged symmetric with respect to a point corresponding to the center of the track on the optical disc 2, so as to receive the light which is reflected and diffracted from the track on the optical disc 2. Output signals from the photodetector 13 are supplied to an RF amplifier 14.

The RF amplifier 14 processes the detection signals from the photodetector 13, generates a focus error signal (FE signal) indicative of an error from a just focus in the axial direction between the signal recording surface and the beam spot, a track error signal (TE signal) indicative of an error in the disc radial direction between the center of the beam spot of the laser beam and the center of the track, and a reproduction signal (RF signal), and delivers the generated FE signal, TE signal and RF signal to an A/D converter 15.

At the time of processing the detection signals from the photodetector 13, the RF amplifier 14 generates the above-described signals by properly setting the parameter values at the time of generating the signals in accordance with the kind of the laser diode 11 that is used.

The RF amplifier 14 of the optical disc apparatus 1 according to the present embodiment includes a track error signal generating unit 14A. As shown in FIG. 2, the track error signal generating unit 14A includes a low-pass filter LPF1, to which an output signal S2 from the light-receiving section 13B is supplied, and a low-pass filter LPF2, to which an output signal S1 from the light-receiving section 13A is supplied.

Output signals from the low-pass filter LPF1 and low-pass filter LPF2 are supplied to a subtracter C1, and the output signal from the low-pass filter LPF2 is subtracted from the output signal from the low-pass filter LPF1. An output signal from the subtracter C1 is delivered to a subtracter C3 as a first track error signal S3.

As shown in FIG. 2, the track error signal generating unit 14A includes a high-pass filter HPF1, to which the output signal S2 from the light-receiving section 13B is supplied, and a high-pass filter HPF2, to which the output signal S1 from the light-receiving section 13A is supplied.

An output signal from the high-pass filter HPF1 is supplied to an envelope detector DET1. An output signal from the high-pass filter HPF2 is supplied to an envelope detector DET2. The envelope detector DET1 and envelope detector DET2 detect envelopes of the high-frequency signals S1 and S2. Specifically, the envelope detector DET1 and envelope detector DET2 extract amplitude levels of the high-frequency signals S1 and S2.

Output signals S4 and S5 from the envelope detector DET1 and envelope detector DET2 are supplied to a subtracter C2, and the output signal S5 from the envelope detector DET2 is subtracted from the output signal S4 from the envelope detector DET1. An output signal from the subtracter C2 is delivered to the subtracter C3 as a high-frequency push-pull signal S6.

In the subtracter C3, the high-frequency push-pull signal S6 is subtracted from the first track error signal S3 that is supplied from the subtracter C1, and the first track error signal S3 is compensated. A second track error signal S7, which is obtained after the compensation, is output from the subtracter C3. In the optical disc apparatus 1 according to the present embodiment, the output signal S7, which is output from the subtracter C3, is supplied to the A/D converter circuit 15 as a TE signal.

The signal from the A/D converter 15 is supplied to a CPU (Central Processing Unit) 21, etc. via a bus 20.

A focus/tracking control circuit 16 generates a focus control signal and a tracking control signal in accordance with the FE signal and TE signal that are supplied from the A/D converter 15, and outputs the focus control signal and tracking control signal to the focusing actuator 7 and tracking actuator 8, thus driving the objective lens 6. Thereby, a focusing servo, which constantly effects just focusing of the laser beam on the information recording surface of the optical disc 2, and a tracking servo, with which the laser beam constantly traces the track formed on the optical disc 2, are executed.

The RF signal is converted to a digital signal by the A/D converter 15, and the digital signal is supplied to a PLL circuit 17 as channel-bit data. The PLL circuit 17 generates, from the data supplied from the A/D converter 15, a reproduction clock, which is synchronized with the data, and channel-bit-unit reproduction data, and outputs them to a data reproduction circuit 18. The data reproduction circuit 18 decodes the format, demodulates the reproduction data and reproduces byte data. The reproduced data is output to an error correction circuit 19.

The error correction circuit 19 executes error correction by using an error correction code which is assigned to the reproduction data, and the error-corrected data is output to the host apparatus 25 via the interface circuit 24.

The disc motor control circuit 4, recording data generating circuit 9, laser control circuit 10, A/D converter circuit 15, focus/tracking control circuit 16, PLL circuit 17, data reproduction circuit 18 and error correction circuit 19 are controlled by the CPU (Central Processing Unit) 21 via the bus 20.

The CPU 21 executes an overall control of the optical disc apparatus 1 in accordance with an operation command which is supplied from the host apparatus 25 via the interface circuit 24. The CPU 21 uses a RAM (Random Access Memory) 22 as a work area of, e.g. a buffer memory at the time of recording/reproduction, and executes a predetermined control according to the a program stored in a ROM (Read-Only Memory) 23.

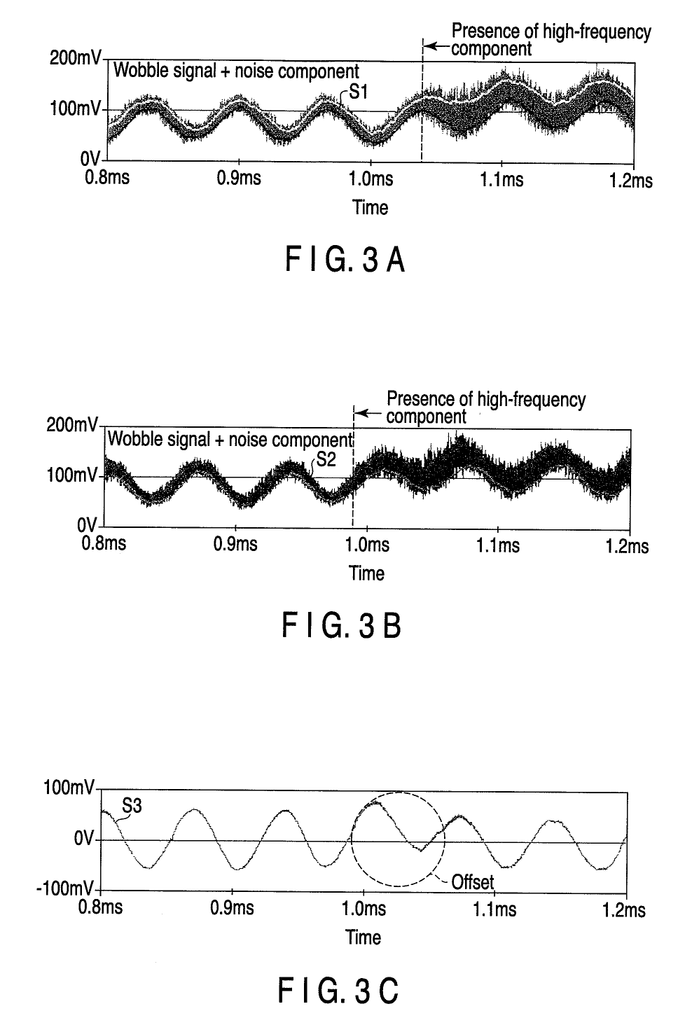

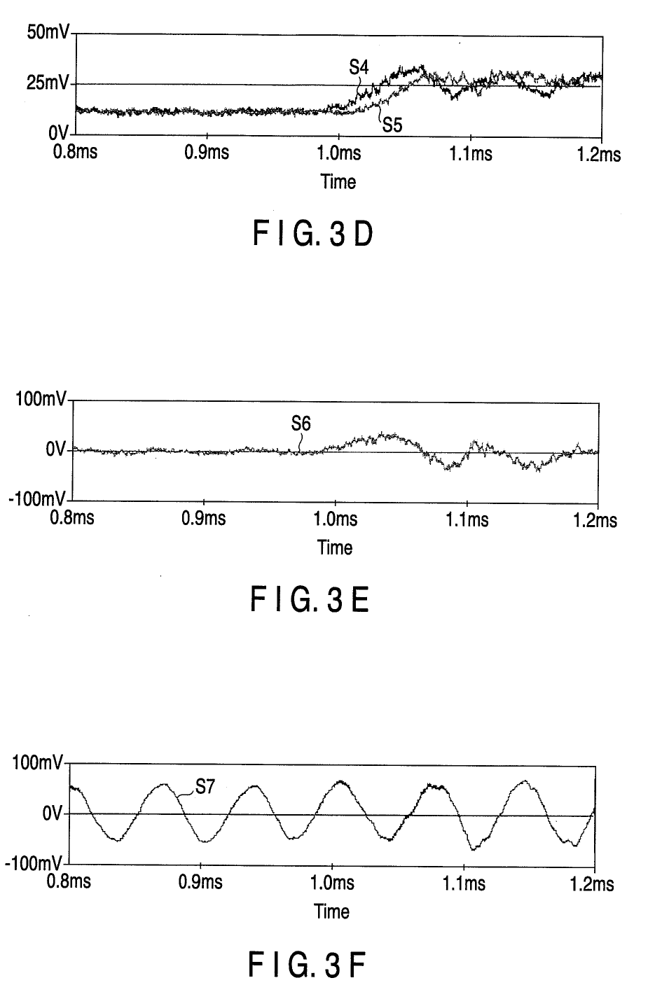

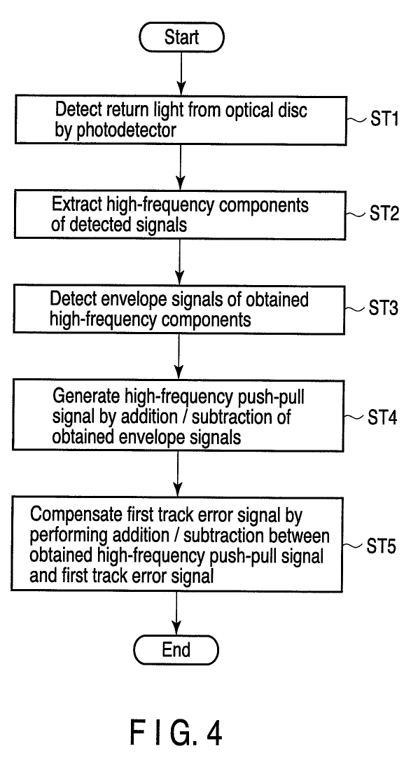

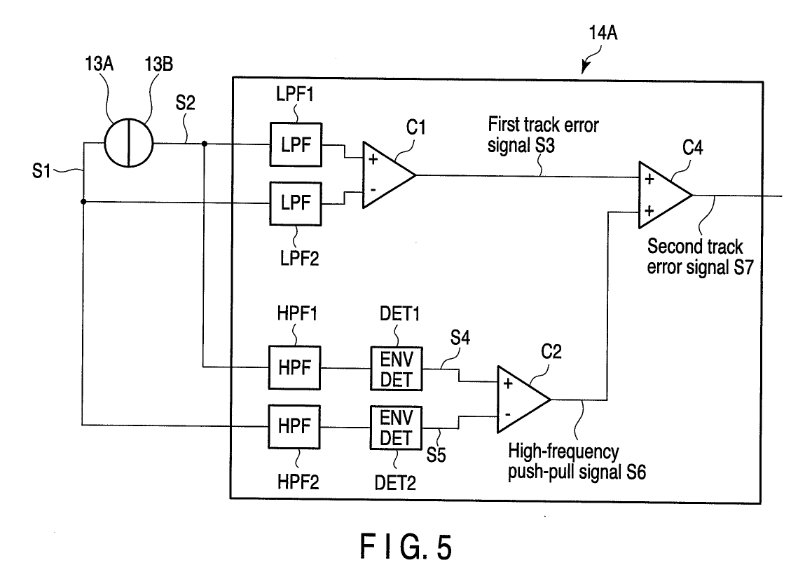

Next, a tracking control method inn the above-described optical disc apparatus 1 is described with reference to the accompanying drawings. The description below is directed to the case in which waveforms shown in FIG. 3A to FIG. 3F are used as examples of waveforms for use in the tracking control, and a track error signal is generated from return light from the optical disc 2 when a laser beam is radiated on a region where a recorded track and a non-recorded track neighbor on the optical disc 2.

If return light from the optical disc 2 is detected by the light-receiving units 13A and 13B of the photodetector 13 (block ST1), an output signal S1, which is output from the light-receiving unit 13A, is supplied to the low-pass filter LPF2, and an output signal S2, which is output from the light-receiving unit 13B, is supplied to the low-pass filter LPF1.

The low-pass filter LPF1 extracts a low-frequency component of the supplied signal S2, and outputs the low-frequency component to the subtracter C1. The low-pass filter LPF2 extracts a low-frequency component of the supplied signal S1, and outputs the low-frequency component to the subtracter C1. The subtracter C1 subtracts the signal, which is supplied from the low-pass filter LPF2, from the signal that is supplied from the low-pass filter LPF1, and outputs a subtraction result as a first track error signal S3.

At this time, in the case where the signals, which are detected by the light-receiving units 13A and 13B, have signal waveforms, as shown in FIG. 3A and FIG. 3B, the first track error signal S3 has a waveform having an offset, as shown in FIG. 3C. The first track error signal S3 is supplied to the subtracter C3.

If attention is paid to the part where the offset occurs in the first track error signal S3, the timing of a transition region, where an amplitude level of the high-frequency component, in which a recording signal is superimposed from the non-recorded state, increases, differs between the output signal S1 from the light-receiving unit 13A and the output signal S2 from the light-receiving unit 13B. The reason for this is that there is a time difference in timing at which the return light of the laser beam that is radiated on the boundary between the recorded track and the non-recorded track of the optical disc 2 is detected by the light-receiving units 13A and 13B.

The initial tracking error signal S3 is a signal which is representative of a difference between low-frequency components (i.e. mean values) which are extracted from the signals that are output from the light-receiving units 13A and 13B. Thus, the offset occurs in the first track error signal S3 due to the timing difference at the transition region.

In the tracking control method according to the present embodiment, the offset, which occurs at the transition period as described above, is compensated in the following manner.

Specifically, if return light from the optical disc 2 is detected by the light-receiving units 13A and 13B (block ST1), the output signal S1, which is output from the light-receiving unit 13A, is supplied to the high-pass filter HPF2, and the output signal S2, which is output from the light-receiving unit 13B, is supplied to the high-pass filter HPF1.

The high-pass filter HPF1 extracts a high-frequency component of the supplied signal S2 (block ST2) and delivers the high-frequency component to the envelope detector DET1. The high-pass filter HPF2 extracts a high-frequency component of the supplied signal S1 (block ST2) and delivers the high-frequency component to the envelope detector DET2. The reason why the high-frequency components of the signals S1 and S2 are extracted is that the levels of the high-frequency components included in the signals S1 and S2 are scarcely affected by the track error and have such properties as to maintain substantially constant amplitude levels.

The envelope detector DET1 detects an envelope signal of the high-frequency signal which is supplied from the high-pass filter HPF1 (block ST3). The envelope detector DET2 detects an envelope signal of the high-frequency signal which is supplied from the high-pass filter HPF2 (block ST3). The envelope signals S4 and SS, which are detected by the envelope detectors DET1 and DET2, are supplied to the subtracter C2. FIG. 3D shows examples of the envelope signals S4 and S5 which are detected by the envelope detectors DET1 and DET2.

The subtracter C2 subtracts the envelope signal S5 from the envelope signal S4 and generates a high-frequency push-pull signal S6 (block ST4). For example, in the case where envelope signals S4 and S5, as shown in FIG. 3D, are obtained by the envelope detectors DET1 and DET2, the high-frequency push-pull signal S6 has a waveform as shown in FIG. 3E. As shown in FIG. 3E, the high-frequency push-pull signal S6 has a feature which is extracted with respect to the transition region of the output signals S1 and S2 from the light-receiving units 13A and 13B. The high-frequency push-pull signal S6, which is output from the subtracter C2, is supplied to the subtracter C3.

The subtracter C3 subtracts the high-frequency push-pull signal S6 from the first track error signal S3 that is supplied, and compensates the first track error signal S3 (block ST5). The subtracter C3 performs an arithmetic operation on the basis of the first track error signal S3 and the high-frequency push-pull signal S6, and outputs the arithmetic result as a second track error signal S7. As shown in FIG. 3F, in the compensated second track error signal S7, the offset in the transition region, which occurs in the first track error signal S3 shown in FIG. 3C, is compensated.

As described above, the second track error signal S7, in which the offset is compensated, is supplied to the A/D converter circuit 15 as the TE signal that is output from the RF amplifier 14. The signal that is output from the A/D converter 15 is supplied to the CPU (Central Processing Unit) 21, etc. via the bus 20.

The focus/tracking control circuit 16 generates the tracking control signal in accordance with the TE signal that is supplied from the A/D converter 15, and outputs the tracking control signal to the tracking actuator 8, thereby driving the objective lens 6. Thus, a tracking servo, with which the laser beam constantly traces the track formed on the optical disc 2, is executed.

As has been described above, the first track error signal S3 is compensated by using the high-frequency push-pull signal S6. Thereby, even in the case where a servo is executed on a non-recorded track whose neighboring track is a recorded track, or on a recorded track whose neighboring track is a non-recorded track, the occurrence of an offset in the track error signal can be suppressed, and the tracking control can be executed without the track servo stability being deteriorated.

Therefore, the present embodiment can provide the optical disc device 1 and tracking control method, which can improve the track servo stability, and can suppress the occurrence of a problem such as track slip.

Next, an optical disc apparatus and a track control method according to a second embodiment of the present invention will now be described with reference to the accompanying drawings. In the description below, the same structural parts as in the optical disc apparatus 1 and tracking control method according to the above-described first embodiment are denoted by like reference numerals, and a description thereof is omitted.

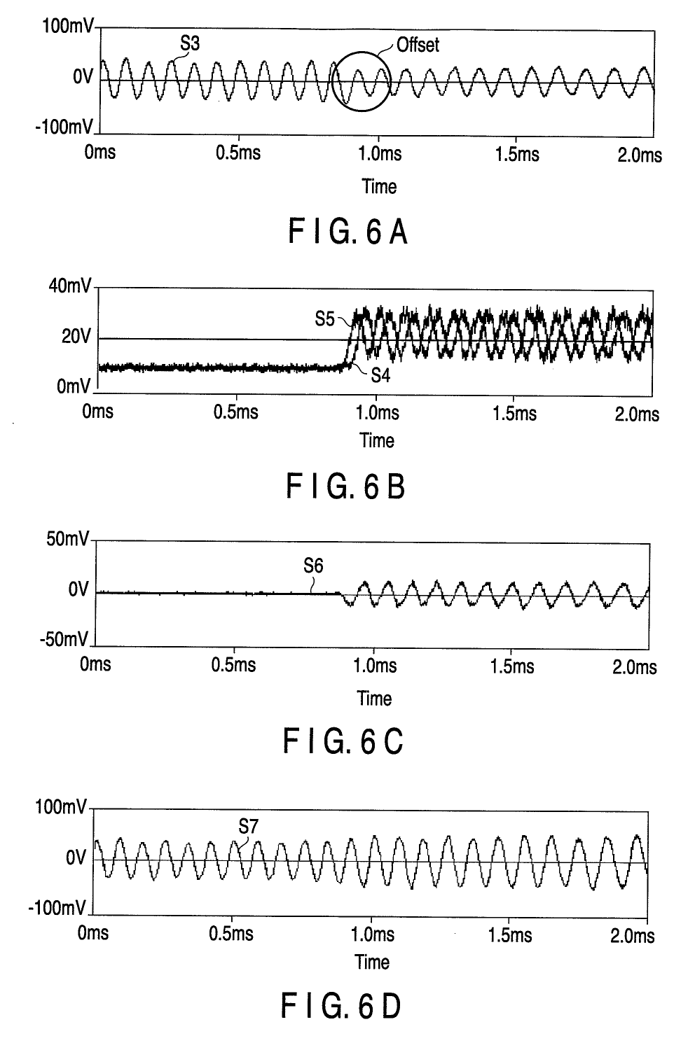

The description below is directed to the case in which waveforms shown in FIG. 6A to 6D are used as examples of waveforms for use in the tracking control, and a track error signal is generated from return light from the optical disc 2 when a laser beam is radiated on a region where a recorded track and a non-recorded track neighbor on the optical disc 2.

The optical disc 2 in the optical disc apparatus 1 according to the present embodiment is formed of an HtoL-type recording material in which the degree of light absorption increases after recording, compared to that before recording. The optical disc apparatus 1 according to the present embodiment includes an adder C4 to which the first track error signal S3, which is output from the subtracter C1, and the high-frequency push-pull signal S6, which is output from the subtracter C2, are supplied.

Specifically, the adder C4 adds the first track error signal S3 and the high-frequency push-pull signal S6, and compensates the first track error signal S3 by the high-frequency push-pull signal S6. The adder C4 outputs a second track error signal S7 after compensation. In the other respects, the optical disc apparatus 1 according to the first embodiment is the same as the optical disc apparatus 1 according to the above-described first embodiment.

In the tracking control method in the optical disc apparatus 1 according to the present embodiment, if return light from the optical disc 2 is detected by the photodetector 13 (block ST1), output signals S1, S2 (not shown), which are output from the light-receiving units 13A and 13B of the photodetector 13, are supplied to the low-pass filters LPF1, LPF2.

The low-pass filter LPF1 extracts a low-frequency component of the supplied signal S2, and outputs the low-frequency component to the subtracter C1. The low-pass filter LPF2 extracts a low-frequency component of the supplied signal S1, and outputs the low-frequency component to the subtracter C1. The subtracter C1 subtracts the signal, which is supplied from the low-pass filter LPF2, from the signal that is supplied from the low-pass filter LPF1, and outputs a subtraction result as a first track error signal S3 to the adder C4. FIG. 6A shows an example of the waveform of the first track error signal S3 in the present embodiment.

On the other hand, the output signals S1, S2 from the light-receiving units 13A, 13B are supplied to the high-pass filters HPF1, HPF2. The high-pass filter HPF1, HPF2 extracts a high-frequency component of the supplied signal S1, S2 (block ST2), and supplies the extracted high-frequency signal to the envelope detector DET1, DET2.

The envelope detectors DET1 and DET2 detect envelopes of the supplied high-frequency signals, and supply the detected envelope signals S4 and S5 to the subtracter C2. As shown in FIG. 6B, the envelope signals S4 and S5 in this embodiment have a phase relationship which is opposite to that in the above-described first embodiment.

The subtracter C2 subtracts the envelope signal S5 from the envelope signal S4 that is supplied and generates a high-frequency push-pull signal S6 (block ST3). The high-frequency push-pull signal S6 is supplied to the adder C4. As shown in FIG. 6C, for example, the high-frequency push-pull signal S6 in this embodiment has a feature which is extracted with respect to the transition region of the output signals S1 and S2 from the light-receiving units 13A and 13B.

The adder C4 compensates the first track error signal S3 by using the high-frequency push-pull signal S6. Specifically, the adder C4 adds the high-frequency push-pull signal S6 to the first track error signal S3, and outputs a compensated second track error signal S7. As shown in FIG. 6D, in the compensated second track error signal S7, the offset in the transition region is compensated.

As described above, the second track error signal S7, in which the offset is compensated, is supplied to the A/D converter circuit 15 as the TE signal. The signal that is output from the A/D converter 15 is supplied to the CPU (Central Processing Unit) 21, etc. via the bus 20.

The focus/tracking control circuit 16 generates the tracking control signal in accordance with the TE signal that is supplied from the A/D converter 15, and outputs the tracking control signal to the tracking actuator 8, thereby driving the objective lens 6. Thus, a tracking servo, with which the laser beam constantly traces the track formed on the optical disc 2, is executed.

As has been described above, the first track error signal S3 is compensated by using the high-frequency push-pull signal S6. Thereby, like the above-described optical disc apparatus 1 and tracking control method according to the first embodiment, even in the case where a servo is executed on a non-recorded track whose neighboring track is a recorded track, or on a recorded track whose neighboring track is a non-recorded track, the occurrence of an offset in the track error signal can be suppressed, and the tracking control can be executed without the track servo stability being deteriorated.

Therefore, the present embodiment can provide the optical disc device 1 and tracking control method, which can improve the track servo stability, and can suppress the occurrence of a problem such as track slip.

The present invention is not limited directly to the above-described embodiments. In practice, the structural elements can be modified and embodied without departing from the spirit of the invention. For example, the optical disc apparatus 1 according to the above-described second embodiment includes the adder C4, it may include polarity inversion means, such as an inverter, for inverting the polarity of the output signal from the subtracter C2.

In the first embodiment, the description is given of the case in which the LtoH type optical disc 2 is used. In the second embodiment, the description is given of the case in which the HtoL type optical disc 2 is used. Alternatively, the LtoH type optical disc 2 and HtoL type optical disc 2 may be used in combination so that the polarity inversion of the high-frequency push-pull signal may be switched by switching means, such as a selector, in accordance with the optical disc that is used. In this case, too, the same advantageous effects can be obtained as in the case of the optical disc apparatus 1 and tracking control method according to the first embodiment and the second embodiment.

Various inventions can be made by properly combining the structural elements disclosed in the embodiments. For example, some structural elements may be omitted from all the structural elements disclosed in the embodiments. Furthermore, structural elements in different embodiments may properly be combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The various modules of the systems described herein can be implemented as software applications, hardware and/or software modules, or components on one more computers, such as servers. While the various modules are illustrated separately, they may share some or all of the same underlying logic or code.

What is claimed is:

1. An optical disc apparatus comprising:
a light source device configured to radiate light on a recording medium;
a light detector configured to detect reflected light from the recording medium;
a track error signal generator configured to generate a second track error signal used for tracking control based on a result from the light detector; and
a tracking controller configured to control tracking based on the second track error signal,
wherein the track error signal generator comprises:
a low-frequency component extraction module configured to extract a plurality of low-frequency components of signals detected by a plurality of light-receivers of the light detector, and to compute a subtract between the plurality of low-frequency components in order to generate a first track error signal;
a high-frequency component extraction module configured to extract high-frequency components of the detected signals detected by the plurality of light-receivers of the light detector;
an envelope signal detector configured to detect envelope signals of the high-frequency components extracted by the high-frequency component extraction module;
a compensation signal generator configured to generate a compensation signal by computing a sum of the detected envelope signals or a subtract between the detected envelope signals; and
a compensation module configured to compensate the first track error signal with the compensation signal in order to generate the second track error signal.

2. The optical disc apparatus of claim 1, further comprising a switch configured to switch between the sum of the detected envelope signals and the subtract between the detected envelope signals, in accordance with the reflected light from the recording medium.

3. A tracking control method comprising:
radiating light on a recording medium;
detecting reflected light from the recording medium by a plurality of light-receivers of a photodetector;
generating a second track error signal used for tracking control based on a result at the light detecting; and
controlling tracking based on the second track error signal,
wherein the generating track error signal comprises:
extracting a plurality of low-frequency components of signals detected by the light detecting;
computing a subtract between the plurality of extracted low-frequency components in order to generate a first track error signal;
extracting a plurality of high-frequency components of the signals detected by the light detecting;
detecting envelope signals of the extracted high-frequency components;
generating a compensation signal by computing a sum of the detected envelope signals or a subtract between the detected envelope signals; and
compensating the first track error signal with the compensation signal in order to generate the second track error signal.

4. The tracking control method of claim 3, further comprising inverting a polarity of the signal computed from either the sum of the envelope signals or the subtract between the envelope signals.
